(19) United States
(12) Patent Application Publication
(10) Pub. No.: US 2025/0135884 A1
(43) Pub. Date: May 1, 2025

(54) DISPLAY DEVICE

(71) Applicant: Panasonic Automotive Systems Co., Ltd., Kanagawa (JP)

(72) Inventor: Hiroaki SATO, Kanagawa (JP)

(73) Assignee: Panasonic Automotive Systems Co., Ltd., Kanagawa (JP)

(21) Appl. No.: 19/000,051

(22) Filed: Dec. 23, 2024

Related U.S. Application Data
(63) Continuation of application No. PCT/JP2023/011583, filed on Mar. 23, 2023.

(30) Foreign Application Priority Data
Jun. 27, 2022 (JP) 2022-102788

(51) Int. Cl. B60K 35/22; G02B 6/42

(52) U.S. Cl. CPC B60K 35/22; G02B 6/4295; B60K 2360/336; B60K 2360/774

(57) ABSTRACT

In a display device, a display panel displays an image. A cover is located closer to a viewer than the display panel and having translucency. The cover has a first surface located on the viewer's side and a second surface located opposite to the first surface. A decorative layer covers at least one of the first surface or the second surface. An illuminance sensor is located on the second surface side and detects illuminance of incident light. A light guide includes a first incidence end, which is an end fixed to the cover, and guides light incident on the first incidence end to the illuminance sensor.

### BACKGROUND

### 1. Field

The present disclosure relates to a display device.

### 2. Description of the Related Art

A display device that controls display luminance based on the output of an illuminance sensor is known (see Patent Literature 1, for example). This display device includes an illuminance sensor installed at a position away from the front of the display panel toward the rear side, and a light guide member installed between the illuminance sensor and the front of the display panel to guide outside light to the illuminance sensor.
Patent Literature 1: Japanese Unexamined Patent Application Publication No. 2014-109701

### SUMMARY

For display devices, further improvement has been required.

To solve the problem above, a display device according to one embodiment of the present disclosure includes: a display panel that displays an image; a cover located closer to a viewer than the display panel and having translucency, the cover including a first surface located on the viewer's side and a second surface located opposite to the first surface; a decorative layer that covers at least one of the first surface or the second surface; an illuminance sensor that is located on the second surface side and that detects illuminance of incident light; and a light guide that includes a first incidence end, which is an end fixed to the cover, the light guide guiding light incident on the first incidence end to the illuminance sensor.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a top view that schematically shows a vehicle on which a display device according to a first embodiment is mounted;

FIG. 2 is a schematic sectional view of the display device according to the first embodiment;

FIG. 3 is a schematic sectional view of a display device according to a second embodiment;

FIG. 4 is a schematic sectional view of a display device according to a third embodiment;

FIG. 5 is a schematic sectional view of a display device according to a modification of the first embodiment;

FIG. 6 is a schematic sectional view of a display device according to a modification of the second embodiment;

FIG. 7 is a schematic sectional view of a display device according to a modification of the third embodiment; and

FIG. 8 is a schematic sectional view of a display device according to a fourth embodiment.

### DETAILED DESCRIPTION

The invention will now be described by reference to the preferred embodiments. This does not intend to limit the scope of the present invention, but to exemplify the invention.

### Base Findings of Present Disclosure

Before specific description of an embodiment is given, the underlying findings will be described. In order to detect the illuminance of light incident on a display device more accurately and to control the luminance of the display device based on the illuminance thus detected, there is a request to provide a light guide for guiding light to an illuminance sensor, near the display area of the display device.

In a display device in which a cover and a decorative layer are arranged on the viewer's side of the display panel and a pattern of the decorative layer can be visually recognized in the display area and the vicinity thereof, the inventor has found the following issues. If a light guide is disposed such as to penetrate through the cover and the decorative layer, in response to the aforementioned request, the decorative layer will not be provided in the area where the light guide is located, which may impair the design and may give a sense of incongruity to the user.

Meanwhile, if the light guide is disposed more inside the display device than the cover and there is air between the light guide and the cover, light will be reflected at each of the interface between the cover and the air and the interface between the air and the light guide. Accordingly, the light reaching the illuminance sensor is reduced, and the illuminance of the light incident on the display device may not be accurately detected, which may make it difficult to properly control the luminance of the display device. In addition, the reflected light may make the light guide be seen through the decorative layer, which may impair the design and may also give a sense of incongruity to the user. To solve these issues, a display device according to the present disclosure is configured as described below.

Like reference characters denote like or corresponding constituting elements, members, and processes in each drawing, and repetitive description will be omitted as appropriate. Also, the dimensions of a member may be appropriately enlarged or reduced in each drawing in order to facilitate understanding.

### First Embodiment

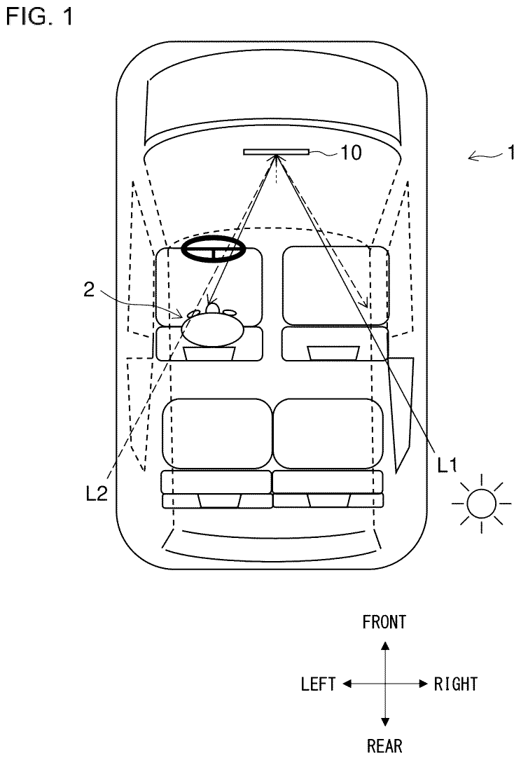

FIG. 1 is a top view that schematically shows a vehicle 1 on which a display device 10 according to the first embodiment is mounted. Although an example will be described in which the display device 10 is a vehicle-mounted display device, the application thereof is not particularly limited. For example, the display device 10 may be a display device of a portable electronic device or a display device of a stationary electronic device.

The display device 10 may be installed, for example, near the center of the center console in a vehicle cabin. The display device 10 displays various information. There is a case where outside light L1, which is sunlight, enters the display surface of the display device 10 through a right rear window of the vehicle 1, and the outside light L1 is specularly reflected on the display surface and directed to an eye of a driver 2 in the left seat. In this case, the driver 2 may have difficulty visually recognizing the content displayed on the display device 10. Accordingly, the display device 10 detects the illuminance near the display surface and increases the screen luminance as the illuminance thus detected is greater. This can improve the visibility of the display device 10 when the illuminance of the incident light is high.

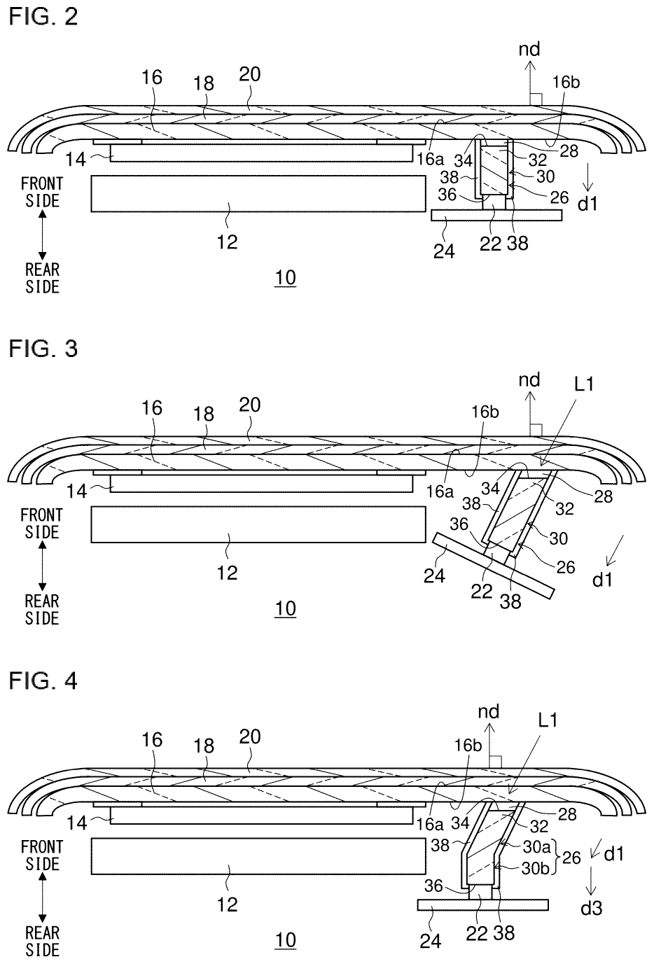

FIG. 2 is a schematic sectional view of the display device 10 according to the first embodiment. The display device 10 includes a display panel 12, a touch panel 14, a cover 16, a decorative layer 18, a surface layer 20, an illuminance sensor 22, a sensor substrate 24, a light guide 26, and an adhesive layer 28.

The display panel 12 displays an image. The display panel 12 can control the display luminance. Although not illustrated, the display panel 12 includes a liquid crystal panel and a backlight that illuminates the liquid crystal panel, for example. The display panel 12 may be a self-luminous panel, such as an organic EL panel. The touch panel 14 is located closer to the front side, i.e., the viewer's side, than the display panel 12 and detects a user's touch to the screen of the display device 10. The touch panel 14 has translucency.

The cover 16 is located closer to the viewer's side than the display panel 12 and the touch panel 14. The cover 16 has translucency. The cover 16 has a first surface 16a located on the viewer's side, and a second surface 16b located opposite to the first surface 16a. The first surface 16a is also referred to as a front face. The decorative layer 18 covers the first surface 16a of the cover 16. The decorative layer 18 has a pattern, such as a wood grain pattern, and has translucency. The decorative layer 18 may be a decorative sheet having a pattern or may be a layer provided by printing or transferring ink onto the cover 16. The surface layer 20 covers the viewer's side of the decorative layer 18. The surface layer 20 has translucency. The surface layer 20 has unevenness formed by matting, for example, and also has a function to diffuse light.

The image displayed on the display panel 12 can be visually recognized from the viewer's side of the surface layer 20. The pattern on the decorative layer 18 can also be visually recognized from the viewer's side, and, in an area overlapping the display panel 12, the pattern superimposed on the displayed image can be visually recognized. Also, the light diffusion function of the surface layer 20 can show the texture of the wood grain, for example. Thus, the design of the display device 10 can be improved. For example, by using the decorative layer 18 with a pattern that matches the interior of the vehicle 1, the display screen of the display device 10 can be blended with the interior of the vehicle 1.

The light guide 26 and the illuminance sensor 22 are located on the second surface 16b side of the cover 16. The light guide 26 extends from the second surface 16b of the cover 16. The light guide 26 includes a columnar portion 30. In the present embodiment, the light guide 26 is constituted only by the columnar portion 30. The columnar portion 30 may have a cylindrical shape or a prism shape. A direction d1 in which the columnar portion 30 extends is parallel to a normal direction nd of the front face of the cover 16. In the following, the front face of the cover 16 means the first surface 16a.

The columnar portion 30 includes a first incidence end 32, which is an end, an incidence surface 34, and an emission surface 36. The first incidence end 32 is fixed to the second surface 16b of the cover 16 via the adhesive layer 28. The decorative layer 18 covers the entirety of the first incidence end 32. The adhesive layer 28 has translucency. The adhesive layer 28 bonds the first incidence end 32 and the cover 16 together. It can also be said that the incidence surface 34 is joined to the second surface 16b of the cover 16 via the adhesive layer 28. The adhesive layer 28 is a layer of a cured adhesive having translucency, for example. As the adhesive, a publicly-known adhesive, such as an optical adhesive or a liquid transparent resin, can be used, for example.

The “bonding” includes “welding”. For example, the cover 16 and the light guide 26 can be welded together using a welding agent or heat. The adhesive layer 28 is a layer formed by a portion of the melted cover 16 and a portion of the melted light guide 26 that have been cured.

The light guide 26 guides, to the illuminance sensor 22, light that has penetrated through the surface layer 20, decorative layer 18, cover 16, and adhesive layer 28 and entered the incidence surface 34 at the first incidence end 32. From the emission surface 36, the light is emitted toward the illuminance sensor 22. The emission surface 36 is parallel to the front face of the cover 16.

The light-receiving surface of the illuminance sensor 22 is fixed to the emission surface 36. The illuminance sensor 22 receives, at the light-receiving surface, the light emitted from the emission surface 36 of the light guide 26 and detects the illuminance of the light incident on the light-receiving surface.

Viewed from the viewer's side, the light guide 26 and the illuminance sensor 22 are arranged next to the display panel 12. Accordingly, the illuminance sensor 22 can detect illuminance close to that of outside light incident on the display panel 12.

The sensor substrate 24 supports the illuminance sensor 22. On the sensor substrate 24, a circuit element for processing an output signal from the illuminance sensor 22 is also mounted. A case 38 covers the periphery of the light guide 26 and accommodates the light guide 26. Although the adhesive layer 28 only bonds the light guide 26 to the cover 16 in FIG. 2, the adhesive layer 28 may also bond the case 38 to the cover 16. Also, the case 38 may be fitted to the cover 16. Further, the case 38 may be bonded to the cover 16 with a member other than the adhesive layer 28, such as double-sided tape.

The cover 16 and the light guide 26 may be formed of the same material or may be formed of different materials. The material of the cover 16 may be polycarbonate, for example, and the material of the light guide 26 may be acrylic, for example. The refractive index of the cover 16 and the refractive index of the light guide 26 are preferably close, and the refractive index of the adhesive layer 28 is preferably close to each of the refractive indices of the cover 16 and the light guide 26. This is because the reflectance at each of the interface between the cover 16 and the adhesive layer 28 and the interface between the adhesive layer 28 and the light guide 26 can be reduced. By forming the cover 16 and the light guide 26 of the same material, the reflected light at the first incidence end 32 of the light guide 26 can be further reduced.

The display panel 12, for example, decreases the screen luminance as the illuminance detected by the illuminance sensor 22 is smaller and increases the screen luminance as the detected illuminance is greater.

According to the embodiment, since the first incidence end 32 of the light guide 26 is fixed to the cover 16 via the adhesive layer 28, the interface between the cover 16 and air and the interface between air and the light guide 26 are not present between the cover 16 and the light guide 26. Accordingly, light that has penetrated through the cover 16 becomes less likely to be reflected at the first incidence end 32, so that the amount of light guided to the illuminance sensor 22 is less likely to decrease. Therefore, the illuminance sensor 22 can detect the illuminance of light incident on the display device 10 more accurately. As a result, the display device 10 can control the screen luminance appropriately, for example.

Also, since the light that has penetrated through the cover 16 is less likely to be reflected at the first incidence end 32, the light guide 26 is less likely to be visually recognized by a viewer through the decorative layer 18. This makes the presence of the light guide 26 less likely to give a sense of incongruity to the viewer.

Also, since the direction d1 in which the columnar portion 30 extends is parallel to the normal direction nd of the front face of the cover 16, light incident parallel to the normal direction nd can be detected accurately. Since the adhesive layer 28 is present, even though the light guide 26, which is a separate component from the cover 16, is used, the interface between the cover 16 and air and the interface between the light guide 26 and air can be easily eliminated.

### Second Embodiment

The second embodiment differs from the first embodiment in the direction in which the light guide 26 extends. In the following, description will be given mainly for the differences from the first embodiment.

FIG. 3 is a schematic sectional view of the display device 10 according to the second embodiment. The direction d1 in which the columnar portion 30 extends intersects the normal direction nd of the front face of the cover 16. The direction d1 is set along the incidence direction of outside light to be detected. For example, in the case of the display device 10 mounted on the vehicle 1 shown in FIG. 1, the direction d1 is set along the incidence direction of the outside light L1.

This enables more accurate detection of the illuminance of the outside light L1 incident on the display device 10 from the direction d1 that intersects the normal direction nd of the front face of the cover 16. Therefore, the luminance of the display panel 12 can be controlled more appropriately with respect to the outside light L1.

In FIG. 1, outside light L2, which enters the display surface of the display device 10 through a left rear window of the vehicle 1, is not directed to the driver 2 even if the outside light L2 is specularly reflected. Therefore, the configuration employed here is designed to improve the accuracy of detecting the illuminance of the outside light L1.

Also, as shown in FIG. 3, the emission surface 36 and the sensor substrate 24 are not parallel to the front face of the cover 16. Since the light guide 26 extends in one direction and is not bent, the loss of light in the light guide 26 can be reduced, compared to the case where there is a bend. Therefore, the illuminance of the incident light can be detected more accurately.

### Third Embodiment

The third embodiment differs from the second embodiment in that the light guide 26 is bent. In the following, description will be given mainly for the differences from the second embodiment.

FIG. 4 is a schematic sectional view of the display device 10 according to the third embodiment. The light guide 26 includes a first columnar portion 30a that includes the incidence surface 34 and the first incidence end 32, and a second columnar portion 30b that includes the emission surface 36. The second columnar portion 30b is connected to the first columnar portion 30a. In other words, the first columnar portion 30a and the second columnar portion 30b are integrally formed. A direction d1 in which the first columnar portion 30a extends is the same as the direction d1 in the second embodiment. A direction d3 in which the second columnar portion 30b extends is parallel to the normal direction nd.

The emission surface 36 is parallel to the front face of the cover 16. Accordingly, the light-receiving surface of the illuminance sensor 22 and the sensor substrate 24 are also parallel to the front face of the cover 16. This can make the thickness of the display device 10 smaller than in the second embodiment. Therefore, the display device 10 can be assembled more easily.

### Modifications of First Through Third Embodiments

In each of the first through third embodiments, the light guide 26 and the cover 16 may be integrally formed. In the following, description will be given mainly for the differences from each of the first through third embodiments.

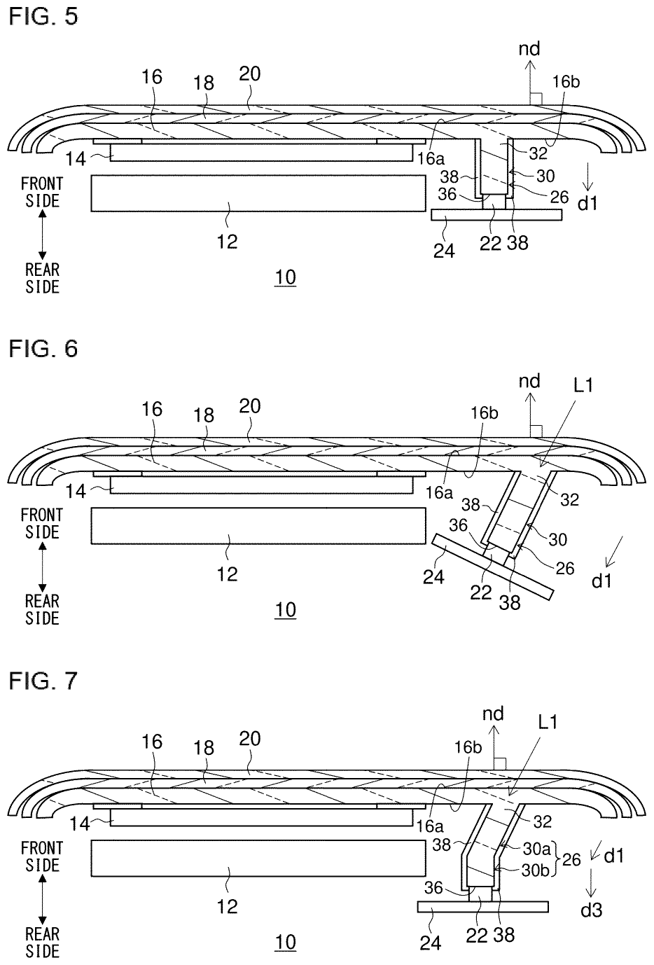

FIG. 5 is a schematic sectional view of the display device 10 according to a modification of the first embodiment. The display device 10 shown in FIG. 5 differs from the display device 10 shown in FIG. 2 in that the light guide 26 and the cover 16 are integrally formed.

FIG. 6 is a schematic sectional view of the display device 10 according to a modification of the second embodiment. The display device 10 shown in FIG. 6 differs from the display device 10 shown in FIG. 3 in that the light guide 26 and the cover 16 are integrally formed.

FIG. 7 is a schematic sectional view of the display device 10 according to a modification of the third embodiment. The display device 10 shown in FIG. 7 differs from the display device 10 shown in FIG. 4 in that the light guide 26 and the cover 16 are integrally formed.

In these configuration examples, the cover 16 with the light guide 26 can be produced by resin molding, for example. The light guide 26 extends from the second surface 16b of the cover 16, and the first incidence end 32 of the light guide 26 is fixed to the second surface 16b of the cover 16. According to these configuration examples, since there is no interface with a refractive index difference between the cover 16 and the light guide 26, reflection of outside light can be further suppressed. Also, the number of parts can be reduced, and the display device 10 can be produced at a lower cost. In addition, the display device 10 can be assembled more easily.

### Fourth Embodiment

The fourth embodiment differs from the third embodiment in that the light guide 26 includes two incidence ends. In the following, description will be given mainly for the differences from the third embodiment.

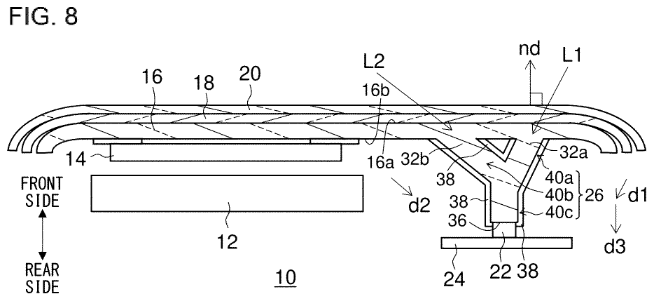

FIG. 8 is a schematic sectional view of the display device 10 according to the fourth embodiment. The light guide 26 extends from the second surface 16b of the cover 16. The light guide 26 includes a first columnar portion 40a, a second columnar portion 40b, and a third columnar portion 40c. The first columnar portion 40a includes a first incidence end 32a, which is an end fixed to the cover 16. The second columnar portion 40b includes a second incidence end 32b, which is also an end fixed to the cover 16. A direction d1 in which the first columnar portion 40a extends intersects a direction d2 in which the second columnar portion 40b extends. Each of the direction d1 and the direction d2 intersects the normal direction nd of the front face of the cover 16. Each of the direction d1 and the direction d2 is set along the incidence direction of outside light to be detected. For example, in the case of the display device 10 mounted on the vehicle 1 shown in FIG. 1, the direction d1 is set along the incidence direction of the outside light L1, and the direction d2 is set along the incidence direction of the outside light L2.

The first columnar portion 40a and the second columnar portion 40b are connected to the third columnar portion 40c. Also, the first columnar portion 40a and the second columnar portion 40b are connected to each other at the portion connected to the third columnar portion 40c. A direction d3 in which the third columnar portion 40c extends is parallel to the normal direction nd. The third columnar portion 40c guides light that has been guided by each of the first columnar portion 40a and the second columnar portion 40b, to the illuminance sensor 22. From the emission surface 36, the light is emitted toward the illuminance sensor 22. The cover 16, first columnar portion 40a, second columnar portion 40b, and third columnar portion 40c are integrally formed by resin molding.

With this configuration, in addition to the accurate detection of the illuminance of the outside light L1, the illuminance of the outside light L2 can also be detected more accurately than in the third embodiment. Therefore, the luminance of the display panel 12 can be controlled more appropriately with respect to the outside light L2, in addition to the outside light L1.

Also, in line with the incidence direction of outside light to be detected, one of the direction d1 or the direction d2 may be parallel to the normal direction nd of the front face of the cover 16. Further, as in the first through third embodiments, the cover 16 and the light guide 26 may be configured as separate parts, and each of the first incidence end 32a and the second incidence end 32b of the light guide 26 may be bonded to the cover 16 via the adhesive layer 28.

The present disclosure has been described based on embodiments. The embodiments are intended to be illustrative only, and it will be obvious to those skilled in the art that various modifications to a combination of constituting elements or processes in the embodiments could be developed and that such modifications also fall within the scope of the present disclosure.

For example, in each of the first through third embodiments, the decorative layer 18 may cover the second surface 16b of the cover 16, instead of the first surface 16a. In this modification, the surface layer 20 covers the first surface 16a of the cover 16. The first incidence end 32 is fixed to the rear of the decorative layer 18 via the adhesive layer 28. In other words, the first incidence end 32 is fixed to the cover 16 via the adhesive layer 28 and the decorative layer 18. This configuration also corresponds to the first incidence end 32 being fixed to the cover 16. Also, in the fourth embodiment, the cover 16 and the light guide 26 may be configured as separate parts, and the decorative layer 18 may cover the second surface 16b of the cover 16 instead of the first surface 16a. In this modification, each of the first incidence end 32a and the second incidence end 32b is fixed to the rear of the decorative layer 18 via the adhesive layer 28. This configuration also corresponds to each of the first incidence end 32a and the second incidence end 32b being fixed to the cover 16. Also in these modifications, since the interface between the cover 16 and air, the interface between the decorative layer 18 and air, and the interface between air and the light guide 26 are not present between the cover 16 and the light guide 26, the aforementioned effects can be obtained. Further, greater flexibility in the configuration of the display device 10 can be allowed.

Further, in each of the first through third embodiments, the decorative layer 18 may cover both the first surface 16a and the second surface 16b of the cover 16. Also in this modification, the first incidence end 32 is fixed to the rear of the decorative layer 18 covering the second surface 16b, via the adhesive layer 28. Also, in the fourth embodiment, the cover 16 and the light guide 26 may be configured as separate parts, and the decorative layer 18 may cover both the first surface 16a and the second surface 16b of the cover 16. Also in this modification, each of the first incidence end 32a and the second incidence end 32b is fixed to the rear of the decorative layer 18 covering the second surface 16b, via the adhesive layer 28. In these modifications, by providing the decorative layer 18 with a pattern on each of the first surface 16a and the second surface 16b, three-dimensional design can be expressed. Accordingly, greater flexibility in the design of the display device 10 can be allowed. Also, by providing the decorative layer 18 on each of the first surface 16a and the second surface 16b, the transmittance and the transparent color of the cover 16 can be adjusted as desired more easily.

One embodiment of the present disclosure is as follows.

### [Item 1]

A display device, including:
a display panel that displays an image;
a cover located closer to a viewer than the display panel and having translucency, the cover including a first surface located on the viewer's side and a second surface located opposite to the first surface;
a decorative layer that covers at least one of the first surface or the second surface;
an illuminance sensor that is located on the second surface side of the cover and that detects illuminance of incident light; and
a light guide that includes a first incidence end, which is an end fixed to the cover, the light guide guiding light incident on the first incidence end to the illuminance sensor.

According to this embodiment, since the first incidence end is fixed to the cover, light that has penetrated through the cover becomes less likely to be reflected at the first incidence end, so that the amount of light guided to the illuminance sensor is less likely to decrease. Therefore, the illuminance sensor can detect the illuminance of light incident on the display device more accurately. Also, since the light that has penetrated through the cover is less likely to be reflected at the first incidence end, the light guide is less likely to be visually recognized by a viewer through the decorative layer. This makes the presence of the light guide less likely to give a sense of incongruity to the viewer.

### [Item 2]

The display device according to Item 1, further including an adhesive layer that bonds the first incidence end of the light guide and the cover.

In this case, even though the light guide, which is a separate component from the cover, is used, the interface between the cover and air and the interface between the light guide and air can be easily eliminated.

### [Item 3]

The display device according to Item 1 or Item 2, wherein the light guide is formed of the same material as the cover.

In this case, the reflected light at the first incidence end of the light guide can be further reduced.

### [Item 4]

The display device according to Item 1, wherein the light guide is formed integrally with the cover.

In this case, the number of parts can be reduced, and the production at a lower cost is enabled. In addition, the display device can be assembled more easily.

### [Item 5]

The display device according to any one of Item 1 through Item 4,
wherein the light guide includes a columnar portion that includes the first incidence end, and
wherein a direction in which the columnar portion extends is parallel to a normal direction of a front face of the cover.

In this case, the illuminance of light incident parallel to the normal direction of the front face of the cover can be detected accurately.

### [Item 6]

The display device according to any one of Item 1 through Item 4,
wherein the light guide includes a columnar portion that includes the first incidence end, and
wherein a direction in which the columnar portion extends intersects a normal direction of a front face of the cover.

In this case, the illuminance of light incident from a direction that intersects the normal direction of the front face of the cover can be detected accurately.

### [Item 7]

The display device according to Item 5 or Item 6,
wherein the light guide includes an emission surface from which light is emitted toward the illuminance sensor, and
wherein the emission surface is parallel to the front face of the cover.

In this case, by disposing the light-receiving surface of the illuminance sensor on the sensor substrate parallel to the emission surface of the light guide, the sensor substrate can be placed parallel to the front face of the cover. This can make the thickness of the display device smaller.

### [Item 8]

The display device according to any one of Item 1 through Item 4,
wherein the light guide includes:
   a first columnar portion that is a columnar portion including the first incidence end;
   a second columnar portion that is a columnar portion including a second incidence end, which is an end fixed to the cover; and
   a third columnar portion that is connected to the first columnar portion and the second columnar portion and that guides light that has been guided by each of the first columnar portion and the second columnar portion, to the illuminance sensor, and
wherein a direction in which the first columnar portion extends intersects a direction in which the second columnar portion extends.

In this case, with regard to each of light incident along the direction in which the first columnar portion extends and light incident along the direction in which the second columnar portion extends, the illuminance can be detected accurately.

### [Item 9]

The display device according to Item 8, wherein a direction in which the first columnar portion extends is parallel to a normal direction of a front face of the cover.

In this case, the illuminance of each of light incident parallel to the normal direction of the front face of the cover and light incident from a direction that intersects the normal direction can be detected accurately.

### [Item 10]

The display device according to Item 8, wherein each of directions in which the first columnar portion and the second columnar portion respectively extend intersects a normal direction of a front face of the cover.

In this case, the illuminance of light incident from each of two directions that intersect the normal direction of the front face of the cover can be detected accurately.

### [Item 11]

The display device according to any one of Item 1 through Item 10, wherein the decorative layer covers the first surface.

While various embodiments have been described herein above, it is to be appreciated that various changes in form and detail may be made without departing from the spirit and scope of the invention(s) presently or hereafter claimed.

### CROSS-REFERENCE TO RELATED APPLICATIONS

This application is a Continuation of International Application No. PCT/JP2023/011583, filed on Mar. 23, 2023, which in turn claims the benefit of Japanese Application No. 2022-102788, filed on Jun. 27, 2022, the disclosures of which Applications are incorporated by reference herein.

What is claimed is:

1. A display device, comprising:
a display panel that displays an image;
a cover located closer to a viewer than the display panel and having translucency, the cover including a first surface located on the viewer's side and a second surface located opposite to the first surface;
a decorative layer that covers at least one of the first surface or the second surface;
an illuminance sensor that is located on the second surface side and that detects illuminance of incident light; and
a light guide that includes a first incidence end, which is an end fixed to the cover, the light guide guiding light incident on the first incidence end to the illuminance sensor.

2. The display device according to claim 1, further comprising an adhesive layer that bonds the first incidence end and the cover.

3. The display device according to claim 1, wherein the light guide is formed of the same material as the cover.

4. The display device according to claim 1, wherein the light guide is formed integrally with the cover.

5. The display device according to claim 1,
wherein the light guide includes a columnar portion that includes the first incidence end, and
wherein a direction in which the columnar portion extends is parallel to a normal direction of the first surface.

6. The display device according to claim 1,
wherein the light guide includes a columnar portion that includes the first incidence end, and
wherein a direction in which the columnar portion extends intersects a normal direction of the first surface.

7. The display device according to claim 6,
wherein the light guide includes an emission surface from which light is emitted toward the illuminance sensor, and
wherein the emission surface is parallel to the first surface.

8. The display device according to claim 1,
wherein the light guide comprises:
a first columnar portion that is a columnar portion including the first incidence end;
a second columnar portion that is a columnar portion including a second incidence end, which is an end fixed to the cover; and
a third columnar portion that is connected to the first columnar portion and the second columnar portion and that guides light that has been guided by each of the first columnar portion and the second columnar portion, to the illuminance sensor, and
wherein a direction in which the first columnar portion extends intersects a direction in which the second columnar portion extends.

9. The display device according to claim 1, wherein the decorative layer covers the first surface.

10. The display device according to claim 1, wherein the decorative layer covers the entirety of the first incidence end.

11. The display device according to claim 8, wherein a direction in which the first columnar portion extends is parallel to a normal direction of the first surface.

12. The display device according to claim 8, wherein each of directions in which the first columnar portion and the second columnar portion respectively extend intersects a normal direction of the first surface.

13. The display device according to claim 2, wherein the adhesive layer has translucency.

14. The display device according to claim 2,
wherein the decorative layer covers the second surface, and
wherein the first incidence end is fixed to the cover via the adhesive layer and the decorative layer.

15. The display device according to claim 1, wherein, when viewed from a viewer's side, the light guide and the illuminance sensor are arranged next to the display panel.
